(19) United States
(12) Patent Application Publication
(10) Pub. No.: US 2018/0154313 A1
(43) Pub. Date: Jun. 7, 2018

(54) FIXTURE DEVICE FOR MEMBRANE ASSEMBLY AND RELATED METHODS

(71) Applicant: Nanostone Water Inc., Eden Prairie, MN (US)

(72) Inventors: Paul Osmundson, Eden Prairie, MN (US); Brian Wise, Eden Prairie, MN (US)

(73) Assignee: Nanostone Water Inc., Eden Prairie, MN (US)

(21) Appl. No.: 15/540,951

(22) PCT Filed: Jan. 6, 2016
(86) PCT No.: PCT/US2016/012365

§ 371 Date: Jun. 29, 2017

Related U.S. Application Data
(60) Provisional application No. 62/100,400, filed on Jan. 6, 2015.

(51) Int. Cl. B01D 65/00; B01D 63/08

(52) U.S. Cl. CPC B01D 65/003; B01D 63/082; B01D 2319/04; B01D 2313/04; B01D 2313/21; B01D 2313/025

(57) ABSTRACT

A filtration assembly includes a membrane housing and at least one membrane fixture device disposed in the housing. Each membrane fixture device has a plurality of membrane fixture members extending from fixture device inner surface, and each membrane fixture device has membrane openings between the membrane fixture members. The filtration assembly further includes a plurality of ceramic membranes each extending from a first membrane end portion to a second membrane end portion, and each first membrane end portion is disposed in one of the membrane openings, where the membrane fixture members fixture the membranes therein.

### PRIORITY CLAIM

This application claims priority to U.S. Provisional Application No. 62/100,400 that was filed on 6 Jan. 2015. The entire content of this provisional application is hereby incorporated herein by reference.

### TECHNICAL FIELD

The present embodiments relate to a membrane assembly with fixture device and related methods.

### BACKGROUND

In the process of manufacturing filtration module assemblies, the assemblies can experience large range of temperatures which can affect the individual components within the assembly and their performance in the field. In addition, the filtration assembly has important sealing requirements which can also be affected during assembly. What is needed is an improved method of manufacture of filtration assemblies.

### SUMMARY

A filtration assembly includes a membrane housing and at least one membrane fixture device disposed in the housing. Each membrane fixture device has a plurality of membrane fixture members extending from fixture device inner surface, and each membrane fixture device has membrane openings between the membrane fixture members. The filtration assembly further includes a plurality of ceramic membranes each extending from a first membrane end portion to a second membrane end portion, and each first membrane end portion is disposed in one of the membrane openings, where the membrane fixture members fixture the membranes therein.

A method for making a filtration assembly includes placing one or more membranes within at least one fixture device, the at least one fixture device including one or more membrane fixture members and an outer sealing portion. The method further includes disposing the one or more membranes between the one or more membrane fixture members, and potting the one or more membranes.

### BRIEF DESCRIPTION OF THE DRAWINGS

In the detailed description of the embodiments presented below, reference is made to the accompanying drawings, in which:

FIG. 1 illustrates a perspective view of a membrane assembly in accordance with one or more embodiments.

FIG. 2A illustrates a perspective view of a membrane ring in accordance with one or more embodiments.

FIG. 2B illustrates a side view of a membrane fixture device in accordance with one or more embodiments.

FIG. 2C illustrates a cross-sectional view of a membrane fixture device taken along 2C-2C in accordance with one or more embodiments.

FIG. 3A illustrates an upper view of a filtration system in accordance with one or more embodiments.

FIG. 3B illustrates a cross-sectional view of a filtration system in accordance with one or more embodiments.

FIG. 4A illustrates an exploded top view of a filtration system in accordance with one or more embodiments.

FIG. 4B illustrates a side view of a filtration system in accordance with one or more embodiments.

FIG. 5A illustrates a perspective view of a membrane ring in accordance with one or more embodiments.

FIG. 5B illustrates a side view of a membrane fixture device in accordance with one or more embodiments.

FIG. 5C illustrates a cross-sectional view of a membrane fixture device taken along 5C-5C in accordance with one or more embodiments.

FIG. 6A illustrates a bottom view of an end cap with a membrane fixture device in accordance with one or more embodiments.

FIG. 6B illustrates a cross-sectional view of an end cap with a membrane fixture device in accordance with one or more embodiments.

The present embodiments are detailed below with reference to the listed figures.

### DETAILED DESCRIPTION OF THE EMBODIMENTS

In the following detailed description, reference is made to the accompanying drawings which farm part of the description, and in which is shown by way of illustration specific embodiments in which the embodiments may be practiced. These embodiments are described in sufficient detail to enable those skilled in the art to practice the invention, and it is to be understood that other embodiments may be practiced in other ways. The following detailed description is not to be taken in a limiting sense, and the scope of the invention is defined by the appended claims and their equivalents.

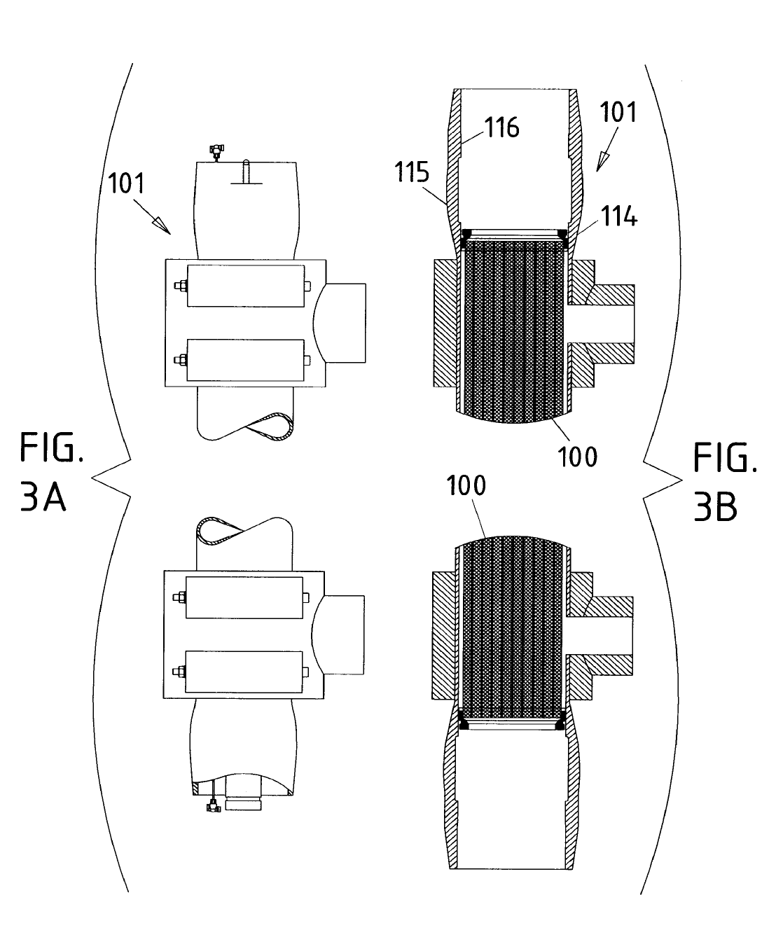

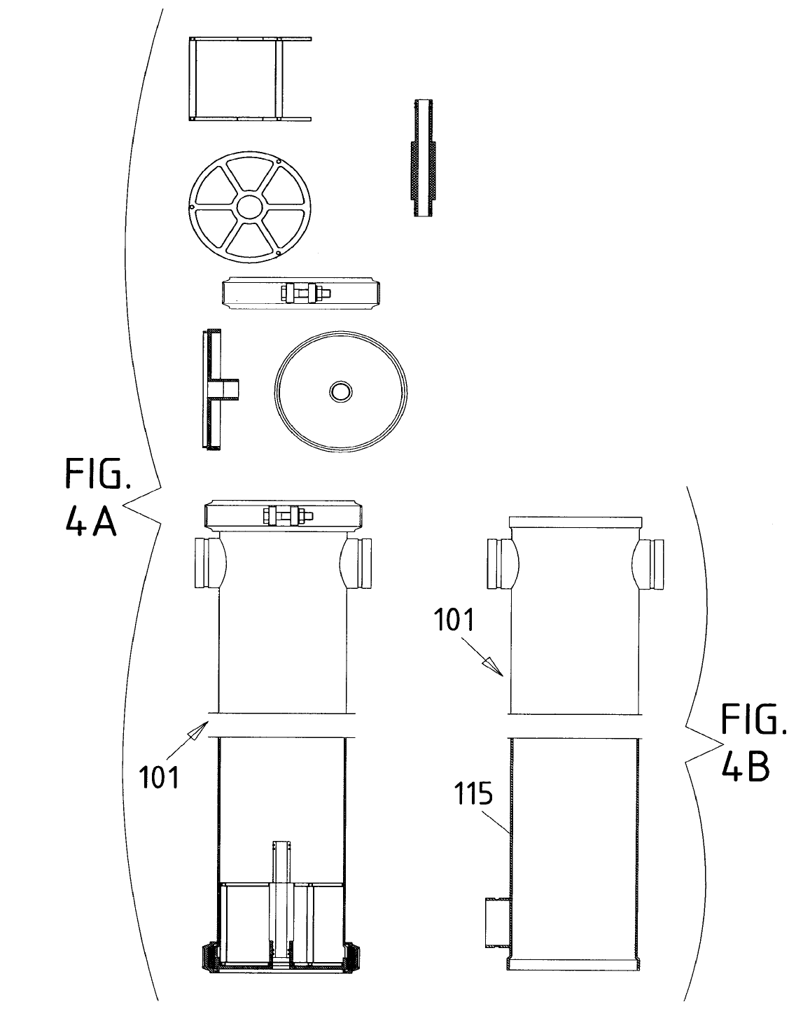

The present embodiments relate to a membrane assembly 100, for example, which can be used in a filtration assembly 101, such as shown in FIGS. 3A, 3B, 4A, 4B for fluid processing and/or separation applications, for example, to treat water in a water treatment plant. In one or more examples, the filtration assembly 101 can be loaded in a basin, used for membrane bioreactor, used for waste affluence, or used in other applications.

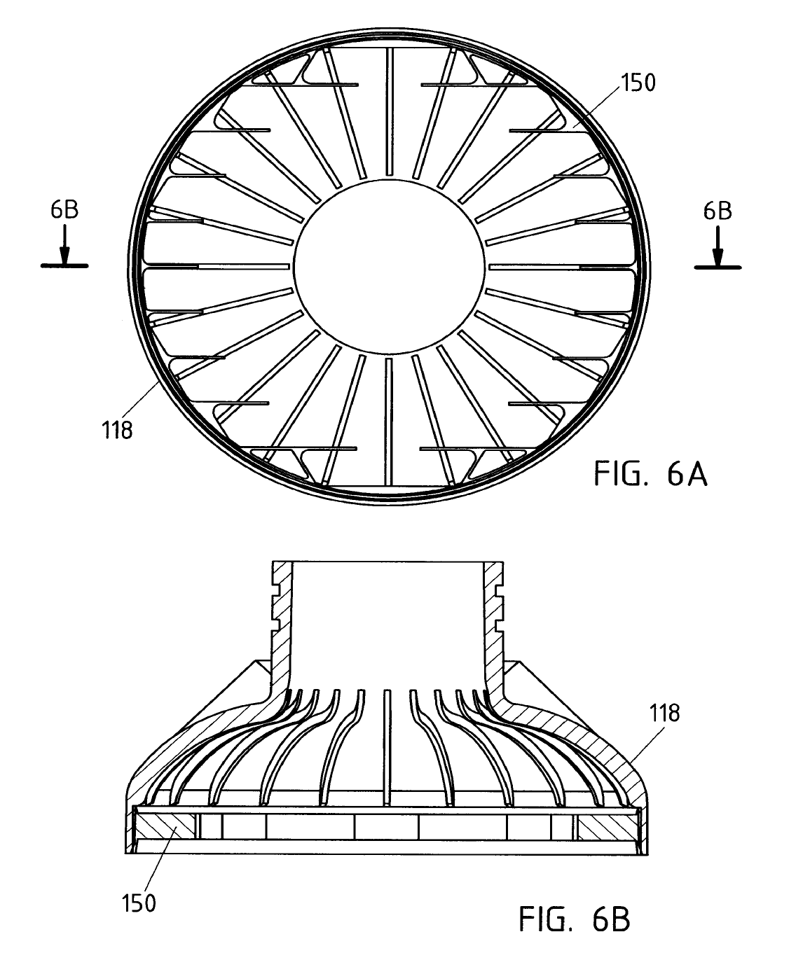

The filtration assembly 101 includes a membrane assembly 100 and a housing 115. The housing 115 receives the membrane assembly 100 therein. The housing 115 extends from a first housing end to a second housing end, and in one or more embodiments includes ports therein. The ports allow for sealing material to be disposed therein. The ends of the housing 115 can be sealed with an end cap 118 (FIGS. 6A, 6B). The housing 115 is defined in part by an external housing surface 114 and an internal housing surface 116.

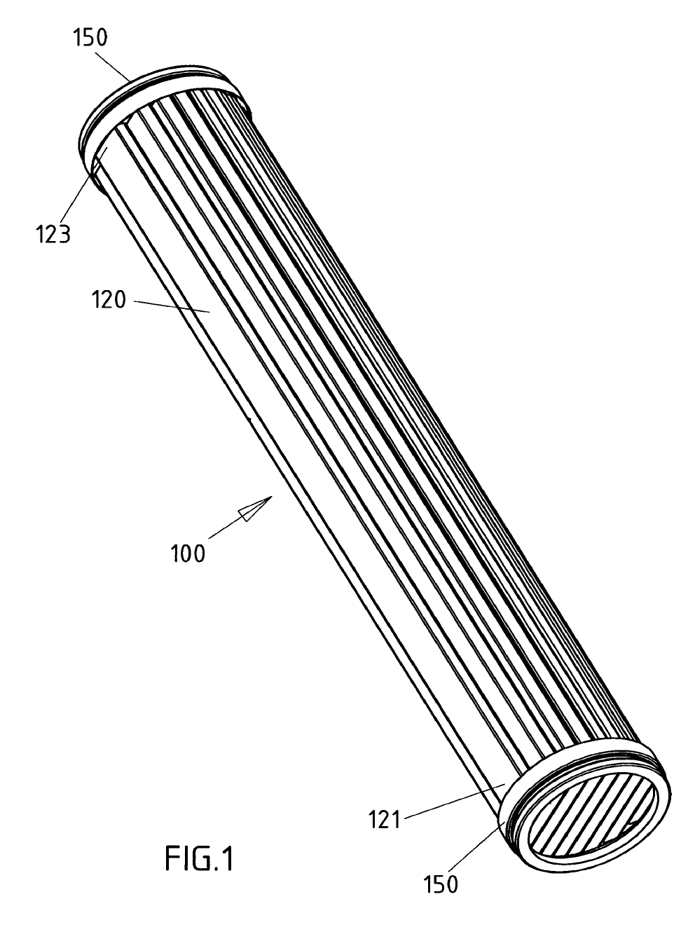

The membrane assembly 100, shown in FIG. 1, includes one or more membranes 120. The membrane 120 in one or more embodiments includes one or more ceramic membranes. The membrane assembly 100, in one or more embodiments, includes one or more of elongate membranes, tubular membranes, flat membranes, or plate membranes. The one or more membranes extend from a first membrane end portion 121 to a second membrane end portion 123.

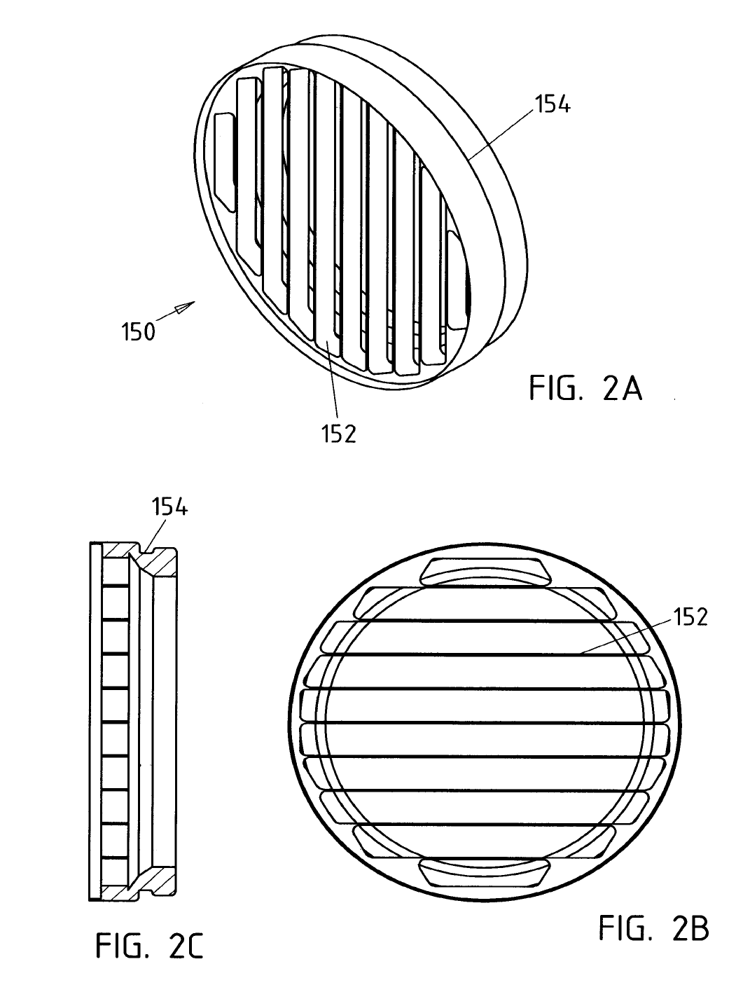

The filtration assembly further includes at least one fixture device, such as at least one membrane fixture device 150 (FIG. 2A-2C). In one or more embodiments, the membrane fixture device 150 has a general ring shape, defined in part by a dimension r, where r is the radius of the fixture device 150. The membrane fixture device 150 is further defined by a ring inner surface and a ring outer surface, such as a ring outer sealing surface.

The at least one fixture device 150 further optionally includes a sealing portion 154. In one or more embodiments, the sealing portion 154 includes a groove, for example, for an o-ring or elastomer. A seal can be further included, such as an elastomeric seal. In one or more embodiments, various shaped seals can be included such as conical seals, wedge shaped seals, O-rings, L-shaped seals, U-cup, or others. A multiple seal configuration can also be included. Sealing surfaces can also be located in the housing as well as on the fixture device 150.

The membrane fixture device 150 is disposed in the housing 115. In one or more embodiments, a first membrane fixture device 150 is disposed at the first housing end, and a second membrane fixture device 150 is disposed at the second housing end. In one or more embodiments, the membrane fixture device 150 is sealed to the housing 115, such as to an internal housing surface and/or to the external housing surface.

The fixture device 150 includes one or more membrane fixture members 152. Within an inner diameter of the ring shape are the membrane fixture members 152, as shown in FIG. 1. Each fixture device 150 has a plurality of membrane fixture members 152 extending from the ring inner surface, where the membrane fixture members 152 are defined by a length 164.

In one or more embodiments, the membrane fixture members 152 each include a chord of the membrane fixture device, where the membrane fixture members 152 each extend from a first side of the membrane fixture device to a second side of the membrane fixture device to form the chord of the circle represented by the fixture device, as shown in FIGS. 2A-2C. For example, the length 164 is defined by a chord of the membrane fixture device 150.

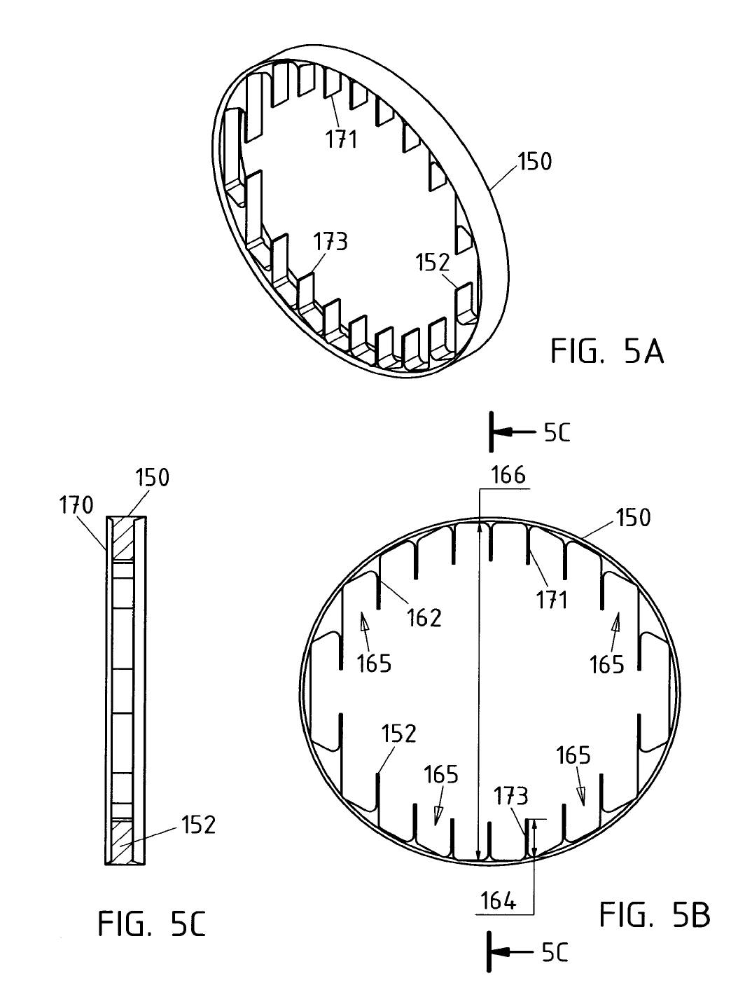

In one or more embodiments, the membrane fixture members 152 extend partially outward from the inner surface of the membrane fixture device 150, such as that shown in FIGS. 5A and 5B. For example, each membrane fixture member 152 includes a first fixture member 171 and a second fixture member 173 that are disposed on opposite sides of the membrane fixture device towards each other, as shown in FIG. 5B. In one or more embodiments, the first and second membrane fixture members have a length 164 that is less than the radius of the inner surface of the membrane fixture device.

In one or more embodiments, the fixture members 152 are spaced apart from one another and have openings 165 therebetween. The openings 165 are defined by an opening length 166. In one or more embodiments, the membrane fixture members 152 are spaced and/or angled to allow the membranes to be slid therebetween during assembly of the membrane assembly. In one or more embodiments, the fixture members 152 are parallel to one another. In one or more embodiments, a majority plane 162 of the membrane fixture members 152 are perpendicular to an end plane 170 of the fixture device 150, and the membrane fixture members 152 have an overall flat, planar shape. The members 152 fixture the membranes therein and hold the membranes to allow for proper potting. In one or more embodiments, a skirt is included, as shown in FIG. 6A.

The at least one fixture device 150 can be made by molding, printing, stamping, or machining, for example, from thermoplastic material. In one or more embodiments, the fixture device 150 is formed of glass filled and/or ceramic material. This will assist with chemical and structural stability during temperature swings during manufacturing or use, as temperatures can move over 100 degrees F.

A method for forming a filtration assembly is further disclosed herein. The method includes assembling the membrane assembly, including placing one or more membranes into the fixture device, for instance into the membrane fixture members. The fixture, in one or more embodiments, is placed on a flat surface, and the membranes are disposed between the fixture members. The method further optionally includes placing a sealing member near, on, or in a sealing portion of the fixture device. In addition, potting material is inserted. In one or more embodiments, the fixture is started up a few inches from a bottom portion of the membrane, and then slid down.

In one or more embodiments, a method for making a filtration assembly includes disposing at least one membrane fixture device into a housing near at least one housing end, placing one or more membranes within at least one membrane fixture device, the membrane fixture device having a plurality of membrane fixture members, each membrane fixture device having membrane openings between the membrane fixture members and an outer sealing portion, wherein placing the one or more membranes within the at least one membrane fixture device includes disposing the one or more membranes between the one or more membrane fixture members and into the membrane openings. The method further includes retaining the one or more membranes with the one or more membrane fixture members, and potting the one or more membranes.

Several options for the method are as follows. For instance, the method further optionally includes sealing the at least one membrane fixture device to the housing. In one or more embodiments, disposing at least one fixture device into the housing includes disposing a first membrane fixture device near a first end of the housing, and disposing a second membrane fixture device near a second end of the housing. In a further option, placing the one or more membranes within the at least one membrane fixture device includes disposing the one or more membranes between the one or more membrane fixture members that are parallel with each other and extend continuously from a first side of the membrane fixture device to a second side of the membrane fixture device. In yet another option, placing the one or more membranes within the at least one membrane fixture device includes disposing the one or more membranes between the one or more membrane fixture members that include a first fixture member and a second fixture member disposed on opposite sides of the membrane fixture device towards each other.

The assembly facilitates the ease of element assembly, and fixtures the element pieces together, helps control temperature expansion and will facilitate the use of drop in elements in standard housing. The fixture device holds the membranes or plates in place during potting, contains potting material during potting, helps control the contraction and expansion when a predetermined thermoplastic and fill material are used. In addition, the fixture device provides a place to hold a seal and provides a sealing surface. Still further, the fixture device accommodates conical sealing.

The fixture device aligns the ceramic membranes and allows the assembly to be efficiently assembled and sealed. It offers the benefit of controlling expansion and contraction and facilitates external sealing of the membrane element to the wall of the housing in which it operates. The sealing used to separate the streams overcomes inner diameter tolerance issues in standard housings.

The embodiments have been described in detail with particular reference to certain embodiments thereof, but it will be understood that variations and modifications can be effected within the scope of the embodiments, especially to those skilled in the art. It should be noted that embodiments or portions thereof discussed in different portions of the description or referred to in different drawings can be combined to form additional embodiments of the present invention. The scope of the invention should, therefore, be determined with reference to the appended claims, along with the full scope of equivalents to which such claims are entitled.

What is claimed is:

1. An assembly comprising:
a membrane housing extending from a first housing end to a second housing end, the membrane housing having an external housing surface and an internal housing surface;
at least one membrane fixture device disposed in the housing, the at least one membrane fixture device disposed at least one of the first end or the second end of the housing, the membrane fixture device having a ring inner surface and a ring outer sealing surface;
each membrane fixture device having a plurality of membrane fixture members extending from the ring inner surface, each membrane fixture device having membrane openings between the membrane fixture members;
a plurality of ceramic membranes each extending from a first membrane end portion to a second membrane end portion; and
each first membrane end portion disposed in one of the membrane openings, where the membrane fixture members fixture the membranes therein.

2. The assembly as recited in claim 1, wherein the at least one membrane fixture device includes a first membrane fixture device and a second membrane fixture device disposed at the first end of the housing and the second end of the housing, respectively.

3. The assembly as recited in claim 1, wherein each membrane fixture member is a chord of the membrane fixture device, the membrane fixture member extends from a first side of the membrane fixture device to a second side of the membrane fixture device forming the chord.

4. The assembly as recited in claim 1, wherein each membrane fixture member has a major plane and the membrane fixture member has an overall flat, planar shape.

5. The assembly as recited in any of claims 1-4, further comprising a seal disposed on an exterior portion of the membrane fixture device.

6. The assembly as recited in claim 5, wherein the seal is disposed in a recess on the exterior portion of the membrane fixture device.

7. The assembly as recited in claim 1, wherein each membrane is a flat membrane.

8. The assembly as recited in any one of claims 1-7, wherein the membrane fixture members are parallel to each other.

9. The assembly as recited in any one of claims 1-2, 5-8, wherein each membrane fixture member includes a first fixture member and a second fixture member disposed on opposite sides of the membrane fixture device towards each other.

10. The assembly as recited in claim 9, wherein the first and second membrane fixture members extend from the inner surface of the membrane fixture device for a distance less than a radius of the membrane fixture device.

11. A method for making a filtration assembly, the method comprising:
disposing at least one membrane fixture device into a housing near at least one housing end;
placing one or more membranes within at least one membrane fixture device, the membrane fixture device having a plurality of membrane fixture members, each membrane fixture device having membrane openings between the membrane fixture members and an outer sealing portion;
wherein placing the one or more membranes within the at least one membrane fixture device includes disposing the one or more membranes between the one or more membrane fixture members and into the membrane openings;
retaining the one or more membranes with the one or more membrane fixture members;
and
potting the one or more membranes.

12. The method as recited in claim 11, further comprising sealing the at least one membrane fixture device to the housing.

13. The method as recited in claim 11, wherein disposing at least one fixture device into the housing includes disposing a first membrane fixture device near a first end of the housing, and disposing a second membrane fixture device near a second end of the housing.

14. The method as recited in claim 11, wherein placing the one or more membranes within the at least one membrane fixture device includes disposing the one or more membranes between the one or more membrane fixture members that are parallel with each other and extend continuously from a first side of the membrane fixture device to a second side of the membrane fixture device.

15. The method as recited in claim 11, wherein placing the one or more membranes within the at least one membrane fixture device includes disposing the one or more membranes between the one or more membrane fixture members that include a first fixture member and a second fixture member disposed on opposite sides of the membrane fixture device towards each other.

16. The method as recited in claim 15, wherein the first and second membrane fixture members extend from the inner surface of the membrane fixture device for a distance less than a radius of the membrane fixture device.
